(19) United States
(12) Patent Application Publication
(10) Pub. No.: US 2001/0029553 A1
(43) Pub. Date: Oct. 11, 2001

(54) Computer farm comprising processor cards with luminous indicator

(76) Inventor: Hugo Delchini, Paris (FR)

Correspondence Address: Robert W. Bergstrom, Summit Law Group PLLC, Suite 300, 1505 Westlake Ave. N., Seattle, WA, 98109, US

(21) Appl. No.: 09/727,914

(22) Filed: Nov. 30, 2000

(30) Foreign Application Priority Data
Apr. 5, 2000 (FR) FR0004362

(51) Int. Cl. G06F 3/00

(52) U.S. Cl. 710/1

(57) ABSTRACT

The invention relates to a computer farm, comprising a bus and processor cards (3) mounted on the bus, each card comprising a luminous indicator (7) provided so as to switch on and switch off when the card is powered up and when it is shut down, wherein said farm comprises a means for switching on and switching off the same luminous indicator (3) upon the input and/or output of data in the card

The present invention relates to a computer farm comprising processor cards with luminous indicators, which cards are mounted on a bus enabling them to exchange data with one another.

It is known that the processor cards of computer farms are insertable into locations provided for this purpose on the bus of the farm.

Upon its insertion, a card is powered up, thereby causing it to start, that is to say causing the execution of initialization programs aimed at allowing it to exchange data with other cards mounted on the bus, via bus read and write cycles.

Generally, the processor card comprises a luminous indicator whose function is to switch on and switch off when the card is powered up and when it is shut down.

This indicator signals, upon the insertion of the card into its location, that the card is powered up and that it is in the process of initializing itself. It switches off when initialization has terminated and the card is ready to be used on the bus.

Likewise, when the user requests the shutdown of the card, for example to extract it, a certain number of switchoff programs are executed so as to free the card. The luminous indicator switches on at the time of the shutdown request and switches off as soon as the switchoff programs have completed their execution. The card can then be removed from its location.

In the course of the normal use of the card in the farm, the luminous indicator does not fulfil any function.

However, in many cases it transpires that one wishes to ascertain the activity of the processor card. Such is the case in particular when the bus is used to simulate a local area network between all the cards mounted on the bus. For this purpose one uses special programs which depict on the screen elements portraying the level of activity of each card.

Thus, in particular, a defective card is detected on account of the fact that its activity level is, if not zero, at least much reduced relative to that of the other processor cards.

However, this solution requires access to a screen in order to represent the requisite information and compels the operator himself to establish the relationship between the activity level displayed and the processor card concerned.

The present invention aims to provide another solution for advising as to the activity level of a processor card.

The computer farm according to the invention is one which comprises a means for switching on and switching off, upon the input and/or output of data in the card, the luminous indicator which is provided solely in order to switch on and switch off when the card is powered up and when it is shut down.

During normal operation, the activity of the card is manifested by repeated switchings-on of the luminous indicator.

When the card exhibits an anomaly of operation, its activity becomes zero and the luminous indicator no longer switches on.

The operator responsible for maintaining the computer farm is thus immediately alerted to the malfunctioning of the card, at the same time as he locates it physically in the farm.

The present invention relates in particular to computer farms containing buses, for example of PCI or CompactPCI type, on which are simulated local area networks, in particular of Ethernet type.

Stated otherwise, in a particular embodiment, the farm comprises a means for simulating a local area network on the bus and the means for switching on the luminous indicator are triggered upon the input and/or the output of a data packet in the card by the simulated network.

In such farms, the invention can also make it possible to discern poor simulation of the network at card level, although the card and its operating system are functioning properly.

With the aim of providing a clearer understanding of the invention, an embodiment thereof given by way of a nonlimiting example will now be described with reference to the appended drawing in which:

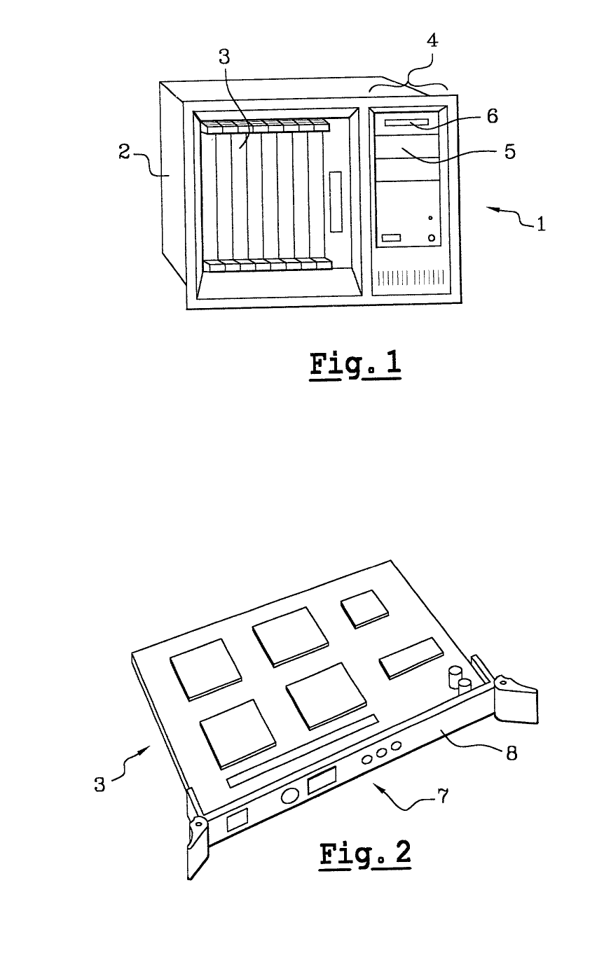

FIG. 1 is a three-quarter perspective front view of a computer farm according to the invention,

FIG. 2 is a perspective view of one of the processor cards of the farm of FIG. 1.

The farm 1 represented in FIG. 1 comprises a box 2 which accommodates a bus (not visible in this figure) on which are mounted eight processor cards 3.

The farm comprises a compartment 4 containing a supply assembly and mass memories consisting in particular of a hard disk 5, as well as a CD ROM drive 6.

The card represented in FIG. 2 complies with the CompactPCI standard.

In particular, it includes a front face 8 which is arranged so as to face the operator and on which there is a luminous indicator 7.

It is this indicator, initially provided so as to switch on only when the card is powered up and when it is shut down, which is used according to the invention to signal the inputs and outputs of data of the card.

The above embodiment is provided merely by way of nonlimiting example and could be modified in any way without thereby departing from the scope of the invention.

1. A computer farm, comprising a bus and processor cards (3) mounted on the bus, each card comprising a luminous indicator (7) provided so as to switch on and switch off when the card is powered up and when it is shut down, wherein said farm comprises a means for switching on and switching off the same luminous indicator (3) upon the input and/or output of data in the card.

2. The computer farm as claimed in claim 1, wherein it comprises a means for simulating a local area network on the bus and wherein the means for switching on the luminous indicator are triggered upon the input and/or the output of a data packet in the card by the simulated network.

3. The computer farm as claimed in either one of claims 1 and 2, wherein the bus is of PCI or CompactPCI type.

4. The computer farm as claimed in any one of claims 1 to 3, wherein the network is an Ethernet network.
